(19) United States
(12) Patent Application Publication
(10) Pub. No.: US 2008/0142650 A1
(43) Pub. Date: Jun. 19, 2008

(54) Structure of the spray gun holder

(75) Inventor: Y. C. Huang, Hsin Chuang City (TW)

Correspondence Address: BIRCH STEWART KOLASCH & BIRCH, PO BOX 747, FALLS CHURCH, VA, 22040-0747, US

(73) Assignee: CHIA CHUNG PRECISION INDUSTRIAL CO., LTD.

(21) Appl. No.: 11/637,821

(22) Filed: Dec. 13, 2006

(51) Int. Cl. B05B 9/03; F16M 11/00

(52) U.S. Cl. 248/161; 239/302

(57) ABSTRACT

An improved structure of the spray gun holder, which mainly comprises a baseplate, a brace, several crotches and a ring support, may hold more than two spray guns at one time, be adaptive to paint cup of various depths and be knocked down into parts at any time. Height of the ring support may be adjusted according to depth of the paint cup so as to meet different models of the spray gun that have particular paint cup. To have easy storage and cost reduction of packing and transportation, the spray gun holder of the present invention can be knocked down and have minimized packing dimensions.

### BACKGROUND OF THE INVENTION

I. Field of the Invention

The present invention relates to an improved structure of the spray gun holder, especially, to a simple structure that is mainly assembled by a base plate, a brace, plural crotches and a ring support. The improved structure may be knocked down into parts so as to compress the packing dimensions for easy storage and minimizing the cost of packing and transportation.

II. Description of the Prior Art

Generally speaking, the spray gun needs a holder to hold it after use for storage or protection, or holding the paint cup for refilling while in use. However, the spray gun holder of a prior art has such structure that comprises a baseplate 41, a connecting unit 42, a fork support 43 and a ring support 44. The baseplate 41 and the connecting unit 42 are two boards that join to each other at a right angle. The fork support for holding the spray gun is installed on one side of the connecting unit 42. The ring support 44, which is extended from the connecting unit 42 and aligns the center of its ring with that of the fork support 43, is used to hold a cone-shape filter 52. The foregoing spray gun holder of a prior art may hold the spray gun by fork support 43 and the cone-shape filter 52 by ring support when the spray gun is not in use or cleaned after use. On the other hand, it may be served as an auxiliary tool by holding the paint cup 51 for refilling. Steps to use the spray gun holder as an auxiliary tool for refilling are: opening lid of the paint cup 51, putting the spray gun 41 on the fork support 43, pulling the paint into the cone-shape filter 52 for refilling the paint cup 51. Following those steps may assure a fast refilling without staining the hands.

Nevertheless, the foregoing spray gun holder of a prior art has following drawbacks: (1) Depth of the paint cup attached to the spray gun 51 must be within the confine between the fork support 43 and the ring support 44; besides, a larger spray gun holder must be purchased if there are more than one spray gun. Consequently, it would cost money and resources and cause troubles in use and storage. (2) The structure, which is fixed and cannot be knocked down, would make the packing dimensions very large, which no doubt takes space when moved in transportation, displayed in store or stored in warehouse. Consequently, the sales and management costs would be raised.

### SUMMARY OF THE INVENTION

To overcome the foregoing drawbacks, the present invention provides an “improved structure of the spray gun holder”.

Main objective of the present invention is to provide an improved structure that holds more than two spray guns at one time and is adaptive to paint cup of various depths by adjusting height of the ring support.

Secondary objective of the present invention is to provide an improved structure that may be knocked down into parts so as to have minimized packing dimensions, resulting in cost reduction of packing and transportation.

To achieve the foregoing objectives, the invention provides an improved structure of the spray gun holder that comprises a baseplate, a brace, several crotches and a ring support. The baseplate is a slab that has a protrusion containing a fish eye in the center. The brace, which covers the foregoing protrusion, is a cavity square prism comprising a bottom plate, more than one set of joining nuts, a mounting boss and a braking part. The bottom plate has a nut corresponding to the foregoing fish eye. Those sets of joining nuts are located on walls of the square prism at appropriate heights. The mounting boss is installed on the top of the square prism and is locked into position by the braking part, which is inserted on one wall of the square prism. Those crotches are Y-shape support comprising an U-shape opening, a stationary plate, which is on the opposite end of the U-shape opening, and several bores corresponding to the joining nuts on the stationary plate. The ring support, which comprises a ring and a rod, is erected by inserted the rod into the foregoing mounting boss and locked into position by the braking part.

Assembly of the foregoing structure is very simple; firstly, erecting the brace on the base plate by screws, attaching those crotches on walls of the brace by screws; secondly, inserting the ring support into the mounting boss, adjusting the direction and height; finally, starting to use. In conclusions, the improved structure provided by the present invention meet the practicability of the industry as it holds more than two spray guns at one time and is adaptive to paint cups of various depths by adjusting heights of the ring support. Furthermore, it may be knocked down into parts before sale so as to have minimized dimensions that reduces the cost of packing and transportation.

### BRIEF DESCRIPTION OF THE DRAWINGS

FIG. 1 is a three-dimensional diagram of the invention.

FIG. 2 is a cross-sectional view of the assembly of the invention.

FIG. 3 is a sectional view of the invention after knock down.

FIG. 4 is a sectional view of the spray gun holder of a prior art.

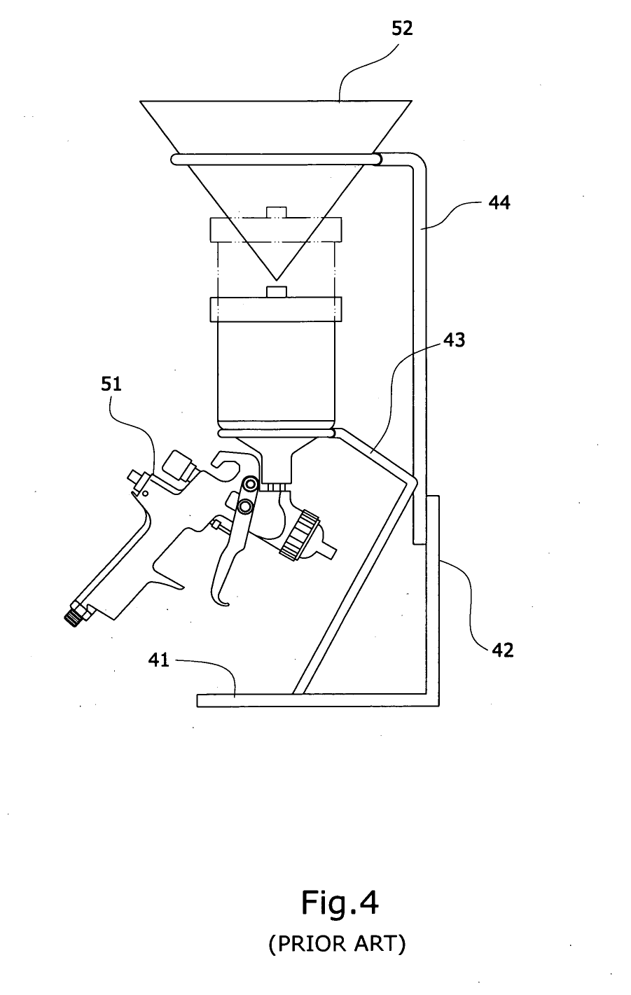

### DESCRIPTION OF THE PREFERRED EMBODIMENTS

Desirable features of the present invention will be better understood from the detailed description and drawings that follow, in which various embodiments of the disclosed invention are illustrated by way of example.

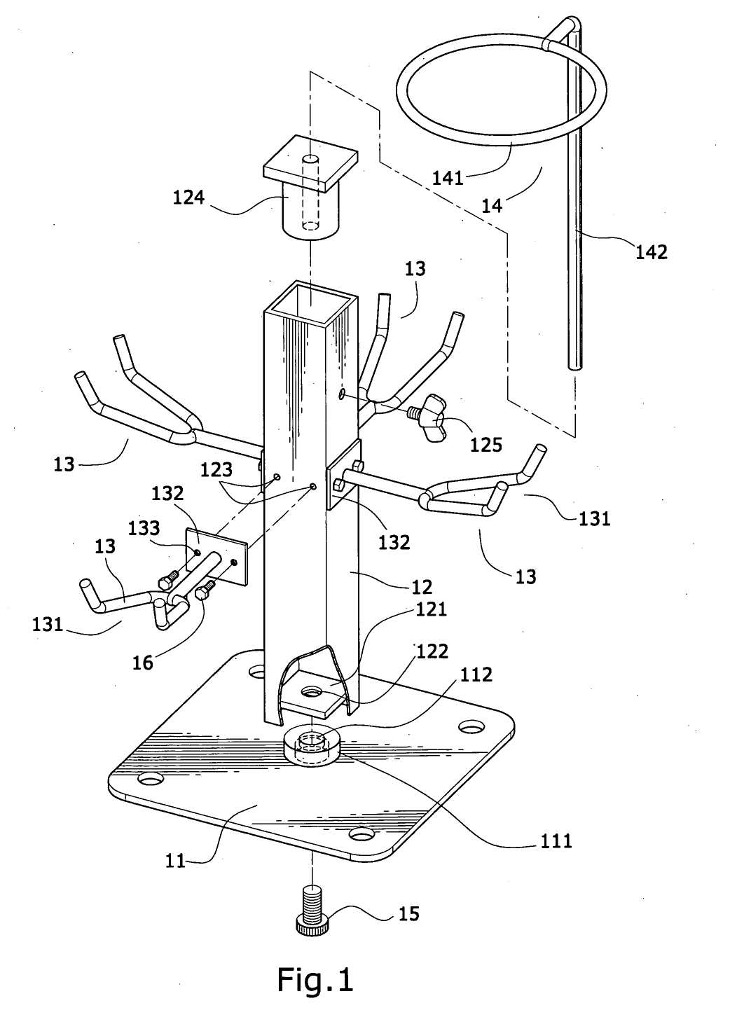

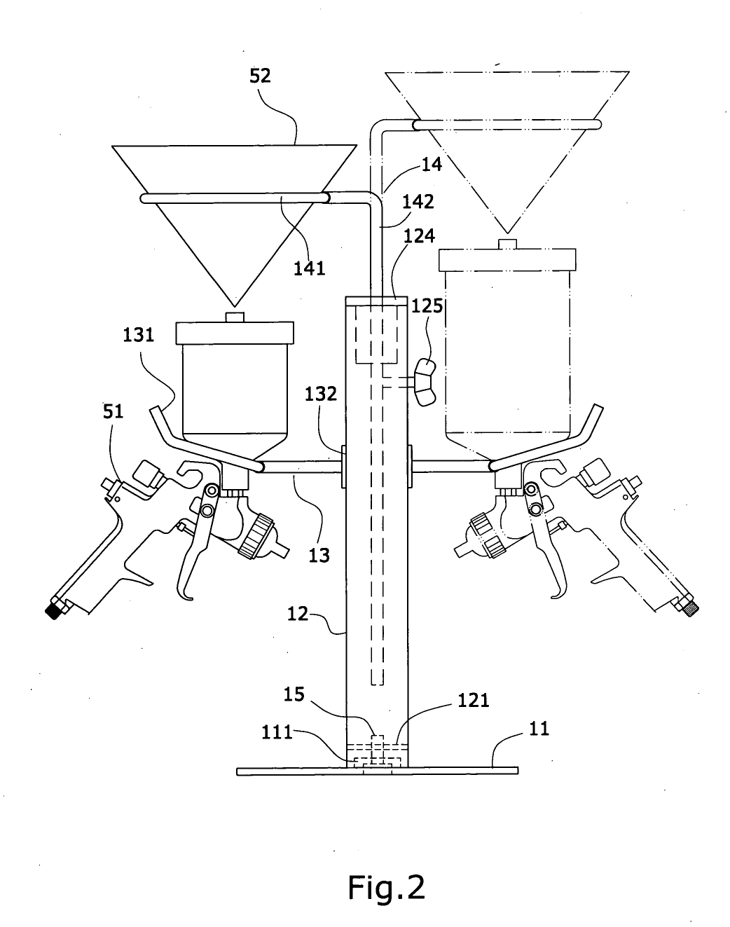

As seen in FIGS. 1 and 2, “the improved structure of spray gun holder” of the invention mainly comprises a baseplate 11, a brace 12, several crotches 12 and a ring support 14. The baseplate 11 is a slab where a protrusion 111 containing a fish eye 112 is protruded from the center. The fish eye is in a shape that becomes smaller by approaching to top from bottom. The brace 12 that covers the protrusion 111 is a cavity square prism comprising a bottom plate 121 where has a nut 122 corresponding to the fish eye 112, more than one set of joining nuts 123 for the crotches to be screwed in, a mounting boss 124 and a braking part 125. Those sets of joining nuts 123 are located on walls of the square prism at appropriate heights. The mounting boss 124 is placed on the top of the square prism and has a braking part 125 that is inserted from one wall of the square prism. The crotches 13 are Y-shape support that has a U-shape opening 131, a stationary plate 132 and several bores 133. The stationary plate 132 is on the opposite end to the U-shape opening 131. Those bores 133 are on the stationary plate 132 and correspond to the joining nuts 123. The ring support 14, which comprises a ring 141 and a rod 142, is erected by inserting the rod into the mounting boss 124 and locked into position by the braking part 125.

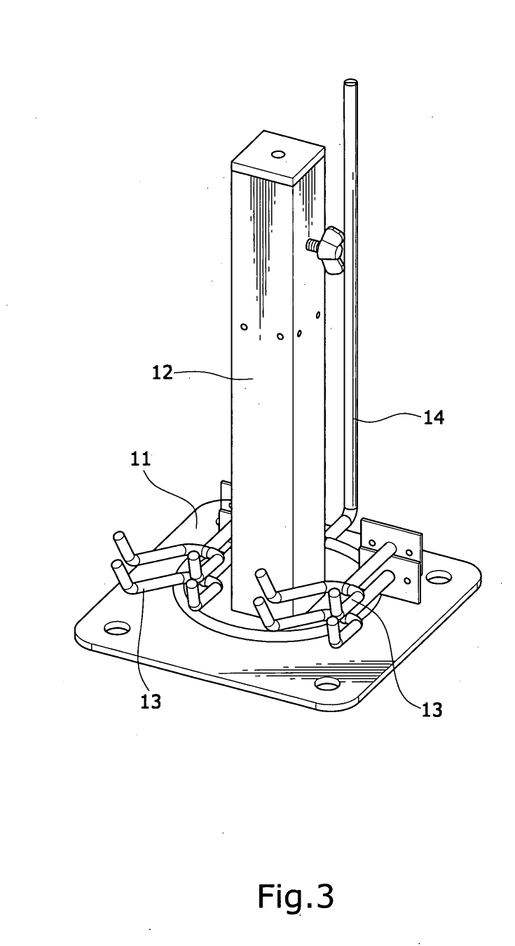

To assemble the foregoing improved structure for use; firstly, erecting the brace 12 on the baseplate 11 by fastening screw 15 and screw 16; secondly, attaching those crotches 13 to walls of the brace 12 by screws; thirdly, erecting the ring support 14 by inserting the rod 12 into the mounting boss 124 on the top of the brace 12; fourthly, locking the ring support 124 into position after adjustment of direction and height; finally, starting to use. According to the foregoing structure, the brace 12 may have two to four crotches 13 according to user's need and space where the spray gun holder is placed so as to hold plural spray guns at one time. Moreover, the height of ring support 14 (illustrated by the dotted line in FIG. 2) may be adjustable according to the depth of paint cup in view paint cup varies by model of the spray gun. These designs exhibit that the present invention possesses the practicability of the industry. Furthermore, the spray gun holder of the present invention can be knocked down (see FIG. 3) so as to have minimized packing dimensions, which would result in easy storage and cost reduction of packing and transportation.

Accordingly, it will thus be seen that the objects set forth above, among those made apparent from the preceding description are efficiently attained and, since certain changes may be made by those who are skilled and knowledgeable in the field in the above constructions without departing from the spirit and scope of the invention, it is intended that all of the matter contained in the above description or shown in the accompanying drawings, shall be interpreted as illustrative, and not as limiting.

To sum up, the “improved structure of the spray gun holder” provided by the present invention achieves in enhancing the practicability as it holds more than two spray guns at one time and is adaptive to paint cup of various depths by adjusting heights of the ring holder. Furthermore, it may be knocked down so as to have minimized packing dimensions that results in easy storage and cost reduction of packing and transportation.

What is claimed is:

1. An improved structure of the spray gun holder mainly comprises a baseplate, a brace, several crotches and a ring support; wherein
a baseplate is a slab where a protrusion containing a fish eye is protruded from the center;
a brace is a cavity square prism that comprises a bottom plate where has a nut corresponding to the foregoing fish eye, more than one set of joining nuts that are located on walls of the square prism at certain heights, a mounting boss on the top of the square prism and a braking part on one wall of the square prism for locking the mounting boss into position;
several crotches are Y-shape support comprising an U-shape opening, a stationary plate at the opposite end of the U-shape opening, and several bores on the stationary plate for combining with the joining nuts;
a ring support comprising a ring and a rod is erected by inserting the rod into the mounting boss and locked into position by the braking part.
